(19) United States
(12) Patent Application Publication
(10) Pub. No.: US 2018/0179793 A1
(43) Pub. Date: Jun. 28, 2018

(54) INSTANT CENTER LATCH SYSTEM

(71) Applicant: GM GLOBAL TECHNOLOGY OPERATIONS LLC, Detroit, MI (US)

(72) Inventors: Wonhee Kim, Shelby Township, MI (US); Paul W Alexander, Ypsilanti, MI (US); James N Nelson, Howell, MI (US); Joshua D Kim, Sterling Heights, MI (US)

(21) Appl. No.: 15/387,743

(22) Filed: Dec. 22, 2016

(51) Int. Cl. E05C 3/12; F16H 21/10

(52) U.S. Cl. CPC E05C 3/124; F16H 21/10

(57) ABSTRACT

A latching device for engaging a striker includes a rotatable locking plate configured for receiving the striker. A linkage is configured to counterbalance the locking plate in a first, latched position. An active material actuator is interconnected with the linkage such that activating the active material actuator moves the linkage out of counterbalance with the locking plate and into a second, unlatched position.

### FIELD

The present disclosure relates to an instant center latch system using a linkage.

### INTRODUCTION

The statements in this section merely provide background information related to the present disclosure and may not constitute prior art.

In many vehicles, the process of releasing a suspended body (e.g., door, hatch, hood or the like) from a supporting body (e.g., vehicle frame) takes place in two consecutive steps. The first step involves releasing the suspended body from a “latch snug-down” and is usually assisted and/or accomplished by an actuator or motor. The seals get compressed during snug-down, thereby enhancing the sealing action. A better sealing action ensures that the communication of undesirable factors (e.g., wind noise, elements of the weather, dust, or the like) to the vehicle interior is attenuated, thus leading to a higher perceived quality of vehicle performance. However, the increased sealing action requires a greater force to release. Once this force is overcome, the second step involves releasing only a remaining mechanical “interlock” between the suspended body and the supporting body. This second step is generally designed to require low to moderate user effort.

### SUMMARY

A latching device for engaging a striker includes a rotatable locking plate configured for receiving the striker. A linkage is configured to counterbalance the locking plate in a first, latched position. An active material actuator is interconnected with the linkage such that activating the active material actuator moves the linkage out of counterbalance with the locking plate and into a second, unlatched position.

A latching device for engaging a striker includes a rotatable locking plate configured for receiving the striker. A linkage is configured to counterbalance the locking plate in a first position. The linkage includes a stationary link having a first and second joint rotationally secured thereto, a position link secured to the first joint and to a third joint, a detent link secured to the third joint and to a fourth joint, and a power link secured to the fourth joint and the second joint. An active material actuator is interconnected with the third joint such that activating the active material actuator moves the detent link out of counterbalance with the locking plate. Furthermore, moving the detent link out of counterbalance with the locking plate causes the locking plate to rotate into a second position.

A latching device for engaging a striker includes a rotatable locking plate configured for receiving the striker. A linkage is configured to counterbalance the locking plate in a first position. A minimal movement of the linkage changes the instant center of the locking plate and moves the locking plate into a second position.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of an exemplary latching device in a first orientation according to the present disclosure;

FIG. 2 is a perspective view of the latching device of FIG. 1 is a second orientation;

FIG. 3 is a perspective view of the latching device of FIG. 1 is a third orientation; and

FIG. 4 is a perspective view of another exemplary latching device according to the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features. Further, directions such as “top,” “side,” “back”, “lower,” and “upper” are used for purposes of explanation and are not intended to require specific orientations unless otherwise stated. These directions are merely provided as a frame of reference with respect to the examples provided, but could be modified in alternate applications.

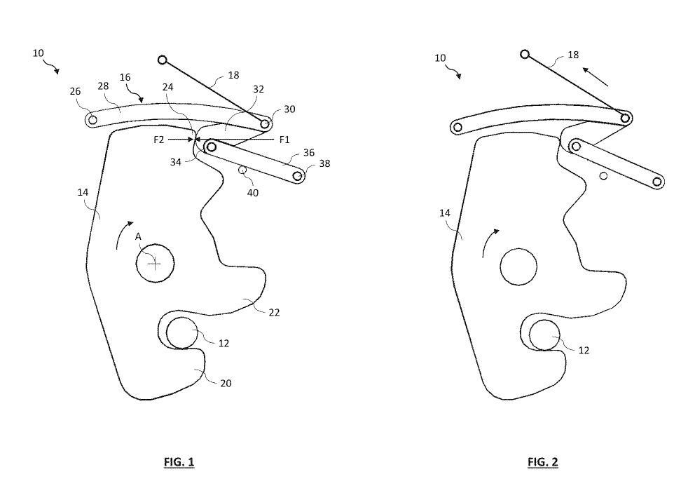

An exemplary latching device 10 for reducing the force and stroke requirements to release a striker 12 is shown and described with respect to FIGS. 1 through 3. As the exemplary latching device 10 does not require full stroke and force to release the striker 12, it is beneficial to systems utilizing an active material based approach to closure (e.g., shape memory alloy actuator). However, the reduced force and stroke requirements can also be beneficial to a latch mechanism using a conventional electromagnetic actuator (e.g., electric motor or solenoid). Closures that utilize shape memory alloy materials to facilitate the latching and unlatching functions are lighter in weight, have a smaller packaging footprint, are quieter in function, are more reliable, and have a lower cost than other systems that employ motors to accomplish these tasks. It should be understood, however, that the disclosure herein is not limited to only active material actuation. In particular, the latching device as described herein could also be activated by a motorized actuator, a manual release by a user, a rod/cable/lever, a geared electrical motor, a piston driven by air or fluid, or the like.

With respect to FIG. 1, the latching device 10 includes a locking plate 14, a four-bar linkage 16, and an active material actuator 18. The locking plate 14 further includes a pair of protruding fingers 20, 22 and an upper engagement surface 24. The pair of protruding fingers 20, 22 are shaped to receive the striker 12 during the latching operation and release the striker 12 during the unlatching operation. The upper engagement surface 24 is shaped to engage with the four-bar linkage 16 during the latching operation and to disengage from the four-bar linkage 16 during the unlatching operation. Furthermore, the locking plate 14 includes a specifically designed body shape so as to provide an instant center between an axis of rotation A of the plate 14 and an applied force F1 from the four-bar linkage 16. In this way, the latching device 10 is in a self-locking mode, wherein the locking plate 14 is precisely counterbalanced at the upper engagement surface 24 by a force F2, equal and opposite to the force F1. While in the self-locking mode, the active material actuator 18 is placed in an OFF mode.

The four-bar linkage 16 consists of four links connected in a loop by four joints so that the links move in a parallel arrangement. The first link (not shown) includes the surface feature to which the four-bar linkage 16 is constrained. The first joint 26 is rotationally pinned to the surface feature and to a position link 28. The position link 28 is rotationally pinned at its opposite end to a second joint 30. The active material actuator 18 is secured to the second joint 30, such that activation/deactivation of the active material actuator 18 causes movement of the four-bar linkage 16. The second joint 30 is also interconnected with a detent link 32. The applied force F1 from the four-bar linkage 16 for counterbalancing the force F2 is directed through the detent link 32, which confronts the locking plate 14 at the upper engagement surface 24. The detent link 32, in turn, is rotationally pinned at its opposite end to a third joint 34. The third joint 34 is also interconnected with a power link 36. The power link 36 supplies the applied force F1 as directed through the detent link 32. In this way, the latching device 10 remains precisely balanced when the active material actuator 18 remains in the OFF mode. The power link 36 is rotationally pinned at its opposite end to a fourth joint 38. The power link 36 is also prevented from moving in one rotational direction by the placement of a stop pin 40. While described and shown as a stop pin, it should be understood that the hard stop can be any type of hard stop, such as, an abutment, rib, bent tab, lance, or other static feature located in the housing or latch frame plate. The fourth joint 38 and the stop pin 40 are also secured to the surface feature (not shown) to which the four-bar linkage 16 is constrained.

Referring now to FIG. 2, the latching device 10 is changed to a self-opening mode through activation of the active material actuator 18. The active material actuator 18 only needs to apply a small force to the four-bar linkage 16 in order to shift the instant center of the system. By changing the applied force F1 from the four-bar linkage 16, the contact point on the locking plate 14 is moved upwardly.

Active materials suitable for use as the active material actuator 18 in the embodiments described herein may be grouped into two functional categories. The first of these two categories of active materials is that of shape memory materials, these being materials or compositions that have the ability to remember their original shape, which can subsequently be recalled by applying an external stimulus, i.e., an activation signal. Exemplary shape memory materials suitable for use in the present disclosure include shape memory alloys, ferromagnetic shape memory alloys, shape memory polymers and composites of the foregoing shape memory materials with non-shape memory materials, and combinations comprising at least one of the foregoing shape memory materials. The second category of active materials suitable for use in the latching device 10 are those that change their shape in proportion to the strength of the applied field but then return to their original shape upon the discontinuation of the field. Exemplary active materials in this category are electroactive polymers (dielectric polymers), piezoelectrics, and piezoceramics. Activation signals can employ an electrical stimulus, a magnetic stimulus, a chemical stimulus, a mechanical stimulus, a thermal stimulus, or a combination comprising at least one of the foregoing stimuli.

Shape memory alloys (SMA) generally refer to a group of metallic materials that demonstrate the ability to return to some previously defined shape or size when subjected to an appropriate thermal stimulus. Shape memory alloys are capable of undergoing phase transitions in which their elastic modulus, yield strength, and shape orientation are altered as a function of temperature. Generally, in the low temperature, or martensite phase, shape memory alloys can be seemingly plastically deformed and upon exposure to some higher temperature will transform to an austenite phase, or parent phase, returning to their shape prior to the deformation. Materials that exhibit this shape memory effect only upon heating are referred to as having one-way shape memory. Those materials that also exhibit shape memory upon re-cooling are referred to as having two-way shape memory behavior.

The temperature at which the shape memory alloy remembers its high temperature form when heated can be adjusted by slight changes in the composition of the alloy and through heat treatment. In nickel-titanium shape memory alloys, for instance, it can be changed from above about 100.degree. C. to below about −100.degree. C. The shape recovery process occurs over a range of just a few degrees and the start or finish of the transformation can be controlled to within a few degrees depending on the alloy composition.

Suitable shape memory alloy materials for fabricating the active elements include nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-palladium based alloys, or the like, or a combination comprising at least one of the foregoing shape memory alloys. The alloys can be binary, ternary, or any higher order so long as the alloy composition exhibits a shape memory effect, e.g., change in shape orientation, changes in yield strength, and/or flexural modulus properties, damping capacity, and the like.

The thermal activation signal may be applied to the shape memory alloy in various ways. It is generally desirable for the thermal activation signal to promote a change in the temperature of the shape memory alloy to a temperature greater than or equal to its austenitic transition temperature. Suitable examples of such thermal activation signals that can promote a change in temperature are the use of steam, hot oil, resistive electrical heating, or the like, or a combination comprising at least one of the foregoing signals. A preferred thermal activation signal is one derived from resistive electrical heating.

It should also be understood that the active element can take a different form. In another example, the active element may be an electrically active polymer. Electrically active polymers are also commonly known as electroactive polymers (EAP). The key design feature of devices based on these materials is the use of compliant electrodes that enable polymer films to expand or contract in the in-plane directions in response to applied electric fields or mechanical stresses. When EAP's are used as the active material, strains of greater than or equal to about 100%, pressures greater than or equal to about 50 kilograms/square centimeter (kg/cm·sup.2) can be developed in response to an applied voltage. The good electromechanical response of these materials, as well as other characteristics such as good environmental tolerance and long-term durability, make them suitable for active elements under a variety of manufacturing conditions. EAP's are suitable for use as an active element in many latching configurations.

In still another example, the active element may be a piezoelectric material configured for providing rapid deployment. As used herein, the term “piezoelectric” is used to describe a material that mechanically deforms (changes shape and/or size) when a voltage potential is applied, or conversely, generates an electrical charge when mechanically deformed. As piezoelectric actuators have a small output stroke, they may also be well-suited for this application.

With continued reference to FIG. 2, after the latching device 10 is changed to the self-opening mode, the instant center changes and the detent link 32 begins rotating upwardly along the upper engagement surface 24. This slight movement is enough to cause the locking plate 14 center to shift. By shifting the center, the locking plate 14 is urged to rotate in a clockwise direction.

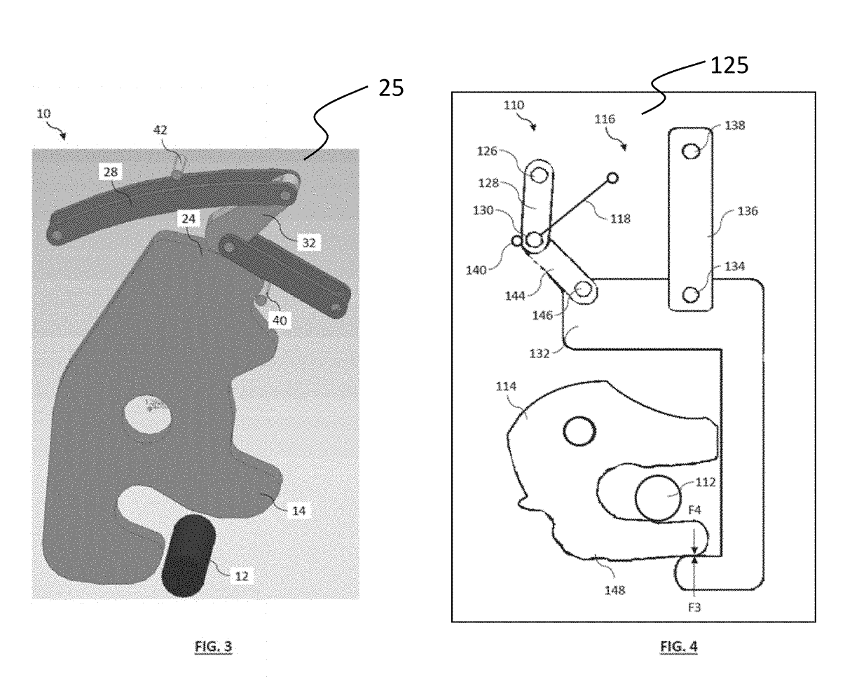

Referring now to FIG. 3, the latching device 10 easily rotates out of engagement with the striker 12. Furthermore, the detent link 32 slides up and over the upper engagement surface 24 to a point where movement is prevented due to the position link 28 contacting a stop pin 42. The locking plate 14 freely rotates clockwise until confronting the stop pin 40. As can be seen, the latching device 10 wants to open/close autonomously. This self-regulated movement requires lower work output for the system and may increase the duty life cycle of the system.

With reference now to FIG. 4, another exemplary latching device 110 is depicted having a locking plate 114 engaging with a striker 112. The latching device 110, however, utilizes a five-bar linkage 116 to effect activation of the device 110. The five-bar linkage 116 includes a surface feature (not shown) to which the five-bar linkage 116 is constrained. A first joint 126 is rotationally pinned to the surface feature and to a first position link 128. The first position link 128 is rotationally pinned at its opposite end to a second joint 130. The active material actuator 118 is secured to the second joint 130, such that activation/deactivation of the active material actuator 118 causes movement of the five-bar linkage 116. The second joint 130 is interconnected with a second position link 144. The second position link 144 is, in turn, interconnected through a joint 146 with a detent link 132. An applied force F3 from the five-bar linkage 116 for counterbalancing a force F4 from the locking plate 114 is directed through the detent link 132, which confronts the locking plate 114 at a lower engagement surface 148. The detent link 132 is also rotationally pinned to a third joint 134. The third joint 134 is also interconnected with a power link 136. The power link 136 supplies the applied force F3 as directed through the detent link 132. In this way, the latching device 110 remains precisely balanced when the active material actuator 118 remains in the OFF mode. The power link 136 is rotationally pinned at its opposite end to a fourth joint 138. The first and second position links 128, 144 are also prevented from moving in one rotational direction by the placement of a stop pin 140. The fourth joint 138 and the stop pin 140 are also secured to the surface feature (not shown) to which the five-bar linkage 116 is constrained.

Embodiments of the present disclosure are described herein. This description is merely exemplary in nature and, thus, variations that do not depart from the gist of the disclosure are intended to be within the scope of the disclosure. While the latching devices 10, 110 above are shown and described as a single position latch, it should be understood that additional engagement surfaces arranged on the locking plate 14, 114 are comprehended. In this way, the latching devices 10, 110 of the present disclosure can also be used with two-position latches, such as those used in vehicle side doors, sliding doors, and liftgate latches.

The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for various applications. Various combinations and modifications of the features consistent with the teachings of this disclosure, however, could be desired for particular applications or implementations.

1. A latching device for engaging a striker, the latching device comprising:
a rotatable locking plate configured for receiving the striker;
a mechanical linkage configured to counterbalance the locking plate in a first, latched position, wherein the linkage includes:
a unitary first bar having a proximal end pivotally secured to a stationary member at a first pivot point;
a unitary second bar having a proximal end pivotally secured to a distal end of the first bar at a second pivot point;
a unitary third bar having a proximal end pivotally secured to a distal end of the second bar at a third pivot point and a distal end of the third bar being pivotally secured to the stationary member at a fourth pivot point; and
an active material actuator interconnected with the linkage at the second bar, wherein the second bar abuts the rotatable locking plate, and wherein activating the active material actuator moves the linkage out of counterbalance with the locking plate and into a second, unlatched position.

2. (canceled)

3. The latching device of claim 1, wherein the rotatable locking plate has a body shaped to provide an instant center between an axis of rotation of the locking plate and an applied force from the linkage.

4. The latching device of claim 1, wherein the linkage is a four-bar linkage.

5. (canceled)

6. The latching device of claim 1, wherein the linkage is constrained from movement in at least one direction by a stop feature.

7. A latching device for engaging a striker, the latching device comprising:
a rotatable locking plate configured for receiving the striker;
a linkage configured to counterbalance the locking plate in a first position, wherein the linkage further comprises:
a stationary link having a first pivot and a second pivot;
a position link having a proximal end pivotally attached to the first pivot and a distal end pivotally attached to a third pivot;
a detent link having a proximal end pivotally attached to the third pivot and a distal end pivotally attached to a fourth pivot;
a power link having a distal end pivotally attached to the fourth pivot and a proximal end pivotally attached to the second pivot; and
an active material actuator directly secured to both the third pivot and to the stationary link, wherein activating the active material actuator moves the detent link out of counterbalance with the locking plate, and wherein moving the detent link out of counterbalance with the locking plate causes the locking plate to rotate into a second position.

8. The latching device of claim 7, wherein the rotatable locking plate includes at least one engagement surface configured to abut the detent link.

9. The latching device of claim 7, wherein the rotatable locking plate has a body shaped to provide an instant center between an axis of rotation of the locking plate and an applied force from the linkage.

10. The latching device of claim 7, wherein the linkage is a four-bar linkage.

11. (canceled)

12. The latching device of claim 7, wherein the linkage is constrained from movement in at least one direction by a stop feature.

13. A latching device for engaging a striker, the latching device comprising:
a rotatable locking plate configured for receiving the striker;
a mechanical linkage having a first link and a second link, each of the first and second links having one end directly secured to a stationary link and another end directly secured to a detent link; and
an active material actuator directly secured to the detent link of the mechanical linkage, wherein the detent link abuts the locking plate in order to counterbalance the locking plate in a first position, and wherein the active material actuator disengages the detent link from engagement with the locking plate in order to move the locking plate into a second position.

14. The latching device of claim 13, wherein the first position is a latched position and the second position is an unlatched position.

15. (canceled)

16. The latching device of claim 13, wherein the rotatable locking plate has a body shaped to provide the instant center between an axis of rotation of the locking plate and an applied force from the linkage.

17. The latching device of claim 13, wherein the linkage is a four-bar linkage.

18. (canceled)

19. The latching device of claim 13, wherein the linkage is constrained from movement in at least one direction by a stop feature.

20. (canceled)
